(19) United States
(12) Patent Application Publication
(10) Pub. No.: US 2023/0017346 A1
(43) Pub. Date: Jan. 19, 2023

(54) POWER CONVERSION DEVICE

(71) Applicant: FUJI ELECTRIC CO., LTD., Kawasaki-shi (JP)

(72) Inventors: Naoki MUKAIYAMA, Sumoto-shi (JP); Hiroki KATSUMATA, Tokyo (JP)

(21) Appl. No.: 17/948,916

(22) Filed: Sep. 20, 2022

Related U.S. Application Data
(63) Continuation of application No. PCT/JP2021/034356, filed on Sep. 17, 2021.

(30) Foreign Application Priority Data
Sep. 28, 2020 (JP) 2020-162318

(51) Int. Cl. H02M 1/14; H02M 7/219; H02M 3/335; H02M 1/00

(52) U.S. Cl. CPC H02M 1/14; H02M 7/219; H02M 3/33573; H02M 1/0067

(57) ABSTRACT

A power conversion device includes a filter circuit unit between a power conversion unit and a smoothing capacitor for smoothing a pulsating flow accompanying power conversion in the power conversion unit to absorb at least a part of a high-frequency component of the pulsating flow.

### CROSS-REFERENCE TO RELATED APPLICATION

This application is a continuation of PCT application PCT/JP2021/034356, filed on Sep. 17, 2021, the disclosure of which is incorporated herein.

### BACKGROUND OF THE INVENTION

### Field of the Invention

The present invention relates to a power conversion device, and more particularly to a power conversion device including a smoothing capacitor for smoothing a pulsating flow accompanying power conversion in a power conversion unit.

### Description of the Background Art

In the related art, a power conversion device including a smoothing capacitor for smoothing a pulsating flow accompanying power conversion in a power conversion unit is disclosed in Japanese Unexamined Patent Publication No. 2017-153236, for example.

A power converter (power conversion device) including a switching circuit (power conversion unit) that converts input alternating-current power into direct-current power and a direct-current connection unit connected to a direct-current power supply or a direct-current load is described in Japanese Unexamined Patent Publication No. 2017-153236. The power converter described in Japanese Unexamined Patent Publication No. 2017-153236 is provided between a switching circuit and a direct-current connection unit and includes a capacitor (smoothing capacitor) that smooths a pulsation (pulsating flow) of a current output from the switching circuit.

The power converter described in Japanese Unexamined Patent Publication No. 2017-153236 includes a pulsation compensation capacitor connected to the direct-current connection unit separately from the smoothing capacitor in order to suppress the pulsation of the current flowing through the direct-current connection unit. Further, the power converter described in Japanese Unexamined Patent Publication No. 2017-153236 includes a boosting unit that performs boosting such that a direct-current voltage of the pulsation compensation capacitor is higher than a direct-current voltage of the direct-current connection unit. Further, the power converter described in Japanese Unexamined Patent Publication No. 2017-153236 includes a control unit that controls an operation of the boosting unit to adjust charge/discharge in the pulsation compensation capacitor. Then, in the power converter described in Japanese Unexamined Patent Publication No. 2017-153236, the pulsation compensation capacitor, the boosting unit, and the control unit are used to assist the function of smoothing the current pulsation by the smoothing capacitor, and thus the smoothing capacitor is suppressed to be increased in size (that is, the number of capacitors used as smoothing capacitors is reduced). Although not described in Japanese Unexamined Patent Publication No. 2017-153236, the smoothing capacitor that smooths the pulsation (pulsating flow) of the current output from the switching circuit is required to have a large capacity, and thus a plurality of capacitors is generally connected in parallel to each other. Further, a capacitor (for example, electrolytic capacitor) used as the smoothing capacitor has a relatively short component life, and thus reduction thereof is desired.

However, the power conversion device described in Japanese Unexamined Patent Publication No. 2017-153236 requires a relatively complicated circuit configuration in order to perform control for assisting the function of smoothing the pulsating flow by the smoothing capacitor. Therefore, in the power conversion device described in Japanese Unexamined Patent Publication No. 2017-153236, although the number of capacitors used as smoothing capacitors is reduced, there is a problem that the circuit configuration becomes relatively complicated.

### SUMMARY OF THE INVENTION

The present invention has been made to solve the above-mentioned problems, and one object of the present invention is to provide a power conversion device capable of reducing the number of capacitors used as smoothing capacitors while suppressing the circuit configuration to be complicated.

In order to achieve the above object, a power conversion device according to one aspect of the present invention includes a power conversion unit that converts input power and outputs converted power, a smoothing capacitor that is provided on an output side or an input side of the power conversion unit and smooths a pulsating flow accompanying power conversion in the power conversion unit, and a filter circuit unit that is provided between the power conversion unit and the smoothing capacitor, includes a reactor and a capacitor for filter, and absorbs at least a part of a high-frequency component of the pulsating flow.

In the power conversion device according to one aspect of the present invention, as described above, the filter circuit unit that absorbs at least a part of the high-frequency component of the pulsating flow is provided between the power conversion unit and the smoothing capacitor. Accordingly, since at least a part of the high-frequency component of the pulsating flow is absorbed by the filter circuit unit, it is possible to reduce the high-frequency component included in the pulsating flow (current pulsation) flowing through the smoothing capacitor. Accordingly, since a total amount of the current flowing through the smoothing capacitor can be reduced, it is possible to reduce the number of capacitors used as the smoothing capacitors required for smoothing the pulsating flow in the smoothing capacitor. Further, in the power conversion device according to the above one aspect, as described above, the filter circuit unit includes the reactor and the capacitor for filter. Accordingly, with the reactor that easily induces a low-frequency component and the capacitor for filter that easily induces the high-frequency component, it is possible to easily induce at least a part of the high-frequency component in the pulsating flow into the capacitor for filter. Accordingly, with the relatively simple configurations of the reactor and the capacitor for filter, it is possible to absorb at least a part of the high-frequency component of the pulsating flow. As a result, it is possible to reduce the number of capacitors used as smoothing capacitors while suppressing the circuit configuration to be complicated. Further, with the adjustment of the resonance frequency of the filter circuit unit, the low-frequency component and the high-frequency component can be easily induced into the reactor and the capacitor for filter, respectively. Therefore, it is possible to configure the reactor and the capacitor for filter used in the filter circuit unit with parts having relatively small capacity. Accordingly, since the filter circuit unit can be made smaller than the capacitor used as the smoothing capacitor, it is possible to expect miniaturization of the device.

Further, in the power conversion device according to the above one aspect, as described above, the filter circuit unit is configured to induce at least a part of the high-frequency component of the pulsating flow into the capacitor for filter and induce a low-frequency component or a direct-current component and a part of remaining of the high-frequency component of the pulsating flow into the reactor. Accordingly, since at least a part of the high-frequency component of the pulsating flow is induced into the capacitor for filter, it is possible to surely absorb at least a part of the high-frequency component of the pulsating flow in the filter circuit unit. Further, since the low-frequency component or the direct-current component and a part of the remaining of the high-frequency component of the pulsating flow are induced into the reactor, it is possible to surely smooth the low-frequency component or the direct-current component and a part of the remaining of the high-frequency component of the pulsating flow with the smoothing capacitor via the reactor.

In the power conversion device according to the above one aspect, it is preferable that a resonance frequency of the filter circuit unit is set to a value lower than at least a frequency of the high-frequency component. In a case where the resonance frequency of the filter circuit unit including the reactor and the capacitor for filter is made lower than the frequency of the high-frequency component, the high-frequency component induced into the capacitor for filter becomes larger than the high-frequency component induced into the reactor. Therefore, with the above configuration, since more than 50% of the high-frequency component can be absorbed by the capacitor for filter in the filter circuit unit, it is possible to surely reduce the high-frequency component included in the pulsating flow flowing through the smoothing capacitor.

In this case, it is preferable that the resonance frequency of the filter circuit unit is set to a value lower than at least half of the frequency of the high-frequency component. In a case where the resonance frequency of the filter circuit unit including the reactor and the capacitor for filter is made lower than half of the frequency of the high-frequency component, the high-frequency component induced into the capacitor for filter is more than four times as large as the high-frequency component induced into the reactor. Therefore, with the above configuration, since more than 80% of the high-frequency component can be absorbed by the capacitor for filter in the filter circuit unit, it is possible to more surely reduce the high-frequency component included in the pulsating flow flowing through the smoothing capacitor.

In the power conversion device according to the above one aspect, it is preferable that the smoothing capacitor is an electrolytic capacitor and the capacitor for filter is a film capacitor. The electrolytic capacitor has a large internal resistance per volume compared with a film capacitor. Thus, an allowable current value per volume (maximum value of current being allowed to flow) is small, but an electrostatic capacity per volume is large. Further, the component other than the high-frequency component of the pulsating flow requires a relatively large electrostatic capacity for the smoothing. In this case, since the number of parallel capacitors is inevitably large, the current flowing through each capacitor is relatively small. That is, the electrolytic capacitor is suitable for smoothing the component other than the high-frequency component in the pulsating flow. On the other hand, the film capacitor has a small internal resistance per volume compared with the electrolytic capacitor. Thus, the allowable current value per volume is large, but the electrostatic capacity per volume is small. Further, the high-frequency component of the pulsating flow does not require a relatively large electrostatic capacity for the smoothing. In this case, since the number of parallel capacitors is inevitably small, the current flowing through each capacitor is relatively large. That is, the film capacitor is suitable for smoothing the high-frequency component. Therefore, with the above configuration, it is possible to efficiently smooth the component other than the high-frequency component of the pulsating flow with the electrolytic capacitor suitable for smoothing the component other than the high-frequency component and efficiently absorb (smooth) the high-frequency component of the pulsating flow with the film capacitor suitable for smoothing the high-frequency components. Accordingly, since the increase in capacity of the capacitor for filter can be suppressed, it is possible to suppress the increase in size of the filter circuit unit.

In the power conversion device according to the above one aspect, it is preferable that the pulsating flow includes the low-frequency component or the direct-current component corresponding to a frequency of the power converted by the power conversion unit and the high-frequency component corresponding to an operation frequency of the power conversion unit. With this configuration, it is possible to effectively use the filter circuit unit configured to induce at least a part of the high-frequency component of the pulsating flow into the capacitor for filter and induce the low-frequency component or the direct-current component and a part of the remaining of the high-frequency component of the pulsating flow into the reactor.

In the power conversion device according to the above one aspect, it is preferable that the power conversion unit includes an AC/DC conversion unit that converts alternating-current power into direct-current power, the smoothing capacitor is configured to smooth an output current output from the AC/DC conversion unit, and the filter circuit unit is configured to absorb at least a part of the high-frequency component from the output current. With this configuration, it is possible to reduce the number of capacitors used as smoothing capacitors for smoothing the output current output from the AC/DC conversion unit.

In the power conversion device according to the above one aspect, it is preferable that the power conversion unit includes a DC/DC conversion unit that converts a voltage of direct-current power, the smoothing capacitor is configured to smooth an input current input to the DC/DC conversion unit, and the filter circuit unit is configured to absorb at least a part of the high-frequency component from the input current. With this configuration, it is possible to reduce the number of capacitors used as smoothing capacitors for smoothing the input current input to the DC/DC conversion unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall configuration of a power conversion device according to an embodiment of the present invention;

FIG. 2 is a diagram for describing separation between a high-frequency component and a low-frequency component by an LC filter provided between an AC/DC conversion unit and a bulk capacitor of the power conversion device according to an embodiment of the present invention;

FIG. 3 is a diagram for describing separation between a high-frequency component and a direct-current component by an LC filter provided between a DC/DC conversion unit and the bulk capacitor of the power conversion device according to an embodiment of the present invention;

FIG. 4 is a diagram for describing a method of designing the LC filter provided between the AC/DC conversion unit and the bulk capacitor of the power conversion device according to an embodiment of the present invention;

FIG. 5 is a diagram for describing a method of designing the LC filter provided between the DC/DC conversion unit and the bulk capacitor of the power conversion device according to an embodiment of the present invention;

FIG. 6 is a diagram showing a circuit configuration 1 (configuration in which no LC filter is provided between the AC/DC conversion unit and the bulk capacitor and between the DC/DC conversion unit and the bulk capacitor) used in simulation;

FIG. 7 is a diagram showing a circuit configuration 2 (configuration in which an LC filter is provided between the AC/DC conversion unit and the bulk capacitor and no LC filter is provided between the DC/DC conversion unit and the bulk capacitor) used in simulation;

FIG. 8 is a diagram showing a circuit configuration 3 (configuration in which no LC filter is provided between the AC/DC conversion unit and the bulk capacitor and an LC filter is provided between the DC/DC conversion unit and the bulk capacitor) used in simulation;

FIGS. 9A, 9B, and 9C are diagrams showing simulation results comparing a case where no LC filter is provided between the AC/DC conversion unit and the bulk capacitor with a case where an LC filter is provided therebetween; and

FIGS. 10A, 10B, and 10C are diagrams showing simulation results comparing a case where no LC filter is provided between the DC/DC conversion unit and the bulk capacitor with a case where an LC filter is provided therebetween.

### DESCRIPTION OF THE PREFERRED EMBODIMENTS

Hereinafter, embodiments embodying the present invention will be described with reference to drawings.

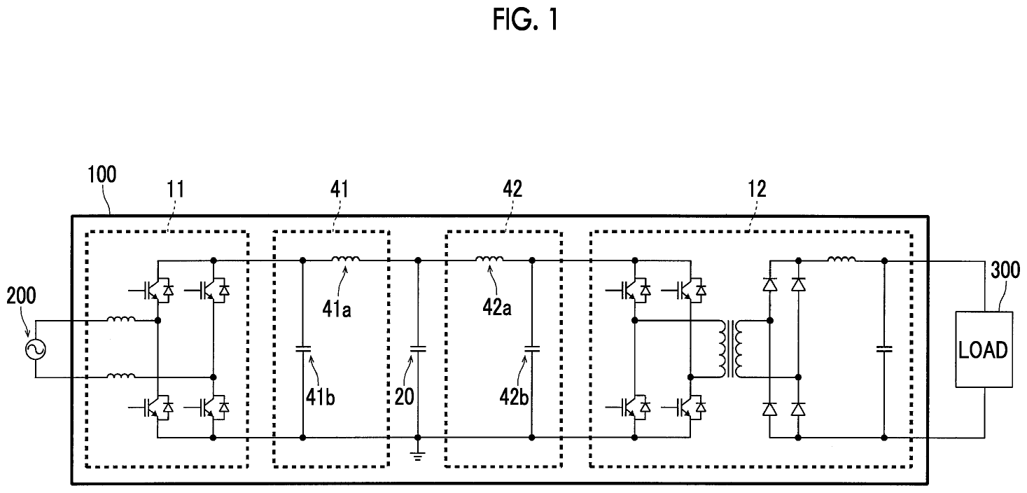

A configuration of a power conversion device 100 according to an embodiment of the present invention will be described with reference to FIGS. 1 to 5.

As shown in FIG. 1, the power conversion device 100 is configured to convert alternating-current power input from a single-phase alternating-current power supply 200 into direct-current power and output the converted power to a load 300. The alternating-current power supply 200 is, for example, a commercial power supply (100 V, 50 Hz/60 Hz). Further, the load 300 is, for example, a device that operates with a direct-current voltage, a battery, or the like.

The power conversion device 100 includes an AC/DC conversion unit 11 and a DC/DC conversion unit 12 that convert input power and output the converted power. The AC/DC conversion unit 11 and the DC/DC conversion unit 12 are examples of “power conversion unit” in the claims.

The AC/DC conversion unit 11 is configured to convert the alternating-current power input from the alternating-current power supply 200 into the direct-current power and output the converted power to a bulk capacitor 20 side, which will be described below. The AC/DC conversion unit 11 is configured to control a plurality of switching elements by pulse width modulation (PWM) to perform the power conversion. The AC/DC conversion unit 11 is configured to perform full-bridge switching.

The DC/DC conversion unit 12 is configured to convert a voltage of the direct-current power input from the bulk capacitor 20 side described below and output the converted voltage to the load 300. The DC/DC conversion unit 12 is configured to control a plurality of switching elements by PWM to perform the power conversion. The DC/DC conversion unit 12 has a full-bridge circuit configuration. The DC/DC conversion unit 12 is configured as a unidirectional power conversion unit.

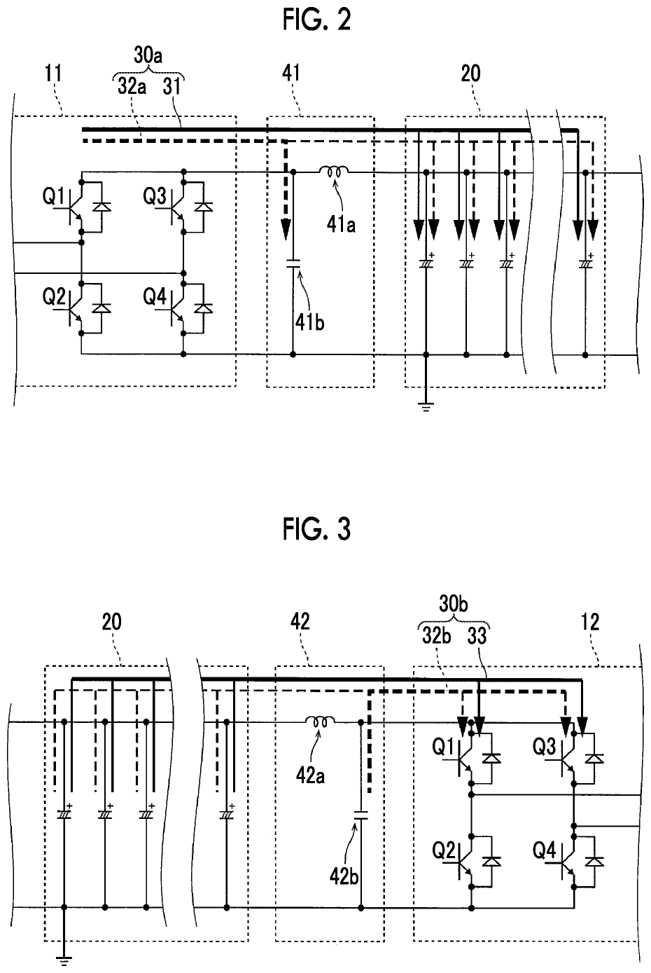

The power conversion device 100 includes a bulk capacitor 20 to smooth a pulsating flow 30a (refer to FIG. 2) accompanying the power conversion in the AC/DC conversion unit 11 and a pulsating flow 30b (refer to FIG. 3) accompanying the power conversion in the DC/DC conversion unit 12. The bulk capacitor 20 is connected in parallel to the AC/DC conversion unit 11 and the DC/DC conversion unit 12 on an output side of the AC/DC conversion unit 11 and an input side of the DC/DC conversion unit 12. The bulk capacitor 20 is an electrolytic capacitor. The electrolytic capacitor has a large internal resistance per volume compared with a film capacitor (described below). Thus, an allowable current value per volume (maximum value of current being allowed to flow) is small, but an electrostatic capacity per volume is large. Further, components other than high-frequency components 32a and 32b of the pulsating flows 30a and 30b require a relatively large electrostatic capacity for the smoothing. In this case, since the number of parallel capacitors is inevitably large, the current flowing through each capacitor is relatively small. That is, the electrolytic capacitor is suitable for smoothing the components other than the high-frequency components 32a and 32b of the pulsating flows 30a and 30b. As shown in FIG. 2, in the bulk capacitor 20, a plurality of electrolytic capacitors is connected in parallel to each other. The pulsating flow 30a and the pulsating flow 30b are examples of “output current” and “input current” in the claims, respectively. Further, the bulk capacitor 20 is an example of “smoothing capacitor” in the claims.

The pulsating flow 30a output from the AC/DC conversion unit 11 to the bulk capacitor 20 side includes a low-frequency component 31 (twice frequency of alternating-current power supply 200 since alternating-current power supply 200 is single-phase) corresponding to a frequency (frequency of alternating-current power supply 200) (50 Hz/60 Hz) of the power converted by the AC/DC conversion unit 11 and the high-frequency component 32a (for example, 60 kHz) corresponding to an operation frequency (of switching) of the AC/DC conversion unit 11. The bulk capacitor 20 is configured to smooth the pulsating flow 30a output from the AC/DC conversion unit 11.

As shown in FIG. 3, the pulsating flow 30b input to the DC/DC conversion unit 12 from the bulk capacitor 20 side has a direct-current component 33 of the power converted by the DC/DC conversion unit 12 and the high-frequency component 32b (for example, 60 kHz) corresponding to an operation frequency (of switching) of the DC/DC conversion unit 12. The bulk capacitor 20 is configured to smooth the pulsating flow 30b input to the DC/DC conversion unit 12.

In the present embodiment, as shown in FIG. 2, the power conversion device 100 is provided between the AC/DC conversion unit 11 and the bulk capacitor 20 and includes an LC filter 41 that absorbs at least a part of the high-frequency components 32a of the pulsating flow 30a. Further, as shown in FIG. 3, the power conversion device 100 is provided between the bulk capacitor 20 and the DC/DC conversion unit 12 and includes an LC filter 42 that absorbs at least a part of the high-frequency components 32b of the pulsating flow 30b. The LC filter 41 and the LC filter 42 are examples of “filter circuit unit” in the claims.

As shown in FIG. 2, the LC filter 41 includes a reactor 41a and a capacitor 41b. In the present embodiment, the capacitor 41b is a film capacitor. The film capacitor has a small internal resistance per volume compared with the electrolytic capacitor. Thus, the allowable current value per volume is large, but the electrostatic capacity per volume is small. The high-frequency components 32a and 32b of the pulsating flows 30a and 30b do not require a relatively large electrostatic capacity for the smoothing. In this case, since the number of parallel capacitors is inevitably small, the current flowing through each capacitor is relatively large. That is, the film capacitor is suitable for smoothing the high-frequency components 32a and 32b of the pulsating flows 30a and 30b. As will be described below, since only a part of the high-frequency component 32a of the pulsating flow 30a flows through the capacitor 41b, a capacity (electrostatic capacity) of the capacitor 41b is set to a very small value (for example, value of one several hundredths) compared with the capacity (electrostatic capacity) of the bulk capacitor 20. The capacitor 41b is an example of “capacitor for filter” in the claims.

The LC filter 41 is configured to induce at least a part of the high-frequency component 32a of the pulsating flow 30a into the capacitor 41b and induce the low-frequency component 31 of the pulsating flow 30a and a part of remaining of the high-frequency component 32a into the reactor 41a. That is, in the present embodiment, the LC filter 41 is configured to absorb at least a part of the high-frequency component 32a from the pulsating flow 30a output from the AC/DC conversion unit 11.

As shown in FIG. 3, the LC filter 42 includes a reactor 42a and a capacitor 42b. In the present embodiment, the capacitor 42b is a film capacitor. As will be described below, since only a part of the high-frequency component 32b of the pulsating flow 30b flows through the capacitor 42b, a capacity (electrostatic capacity) of the capacitor 42b is set to a very small value (for example, value of one several hundredths) compared with the capacity (electrostatic capacity) of the bulk capacitor 20. The capacitor 42b is an example of “capacitor for filter” in the claims.

The LC filter 42 is configured to induce at least a part of the high-frequency component 32b of the pulsating flow 30b into the capacitor 42b and induce the direct-current component 33 of the pulsating flow 30b and a part of remaining of the high-frequency component 32b into the reactor 42a. That is, in the present embodiment, the LC filter 42 is configured to absorb at least a part of the high-frequency component 32b from the pulsating flow 30b input to the DC/DC conversion unit 12.

Here, in a case where a resonance frequency fᵣ of the LC filters 41 and 42 including the reactors 41a and 42a and the capacitors 41b and 42b is made lower than half of a frequency f_{rip_h} of the high-frequency components 32a and 32b, the high-frequency components 32a and 32b induced into the capacitors 41b and 42b are more than four times as large as the high-frequency components 32a and 32b induced into the reactors 41a and 42a. Therefore, in the present embodiment, the resonance frequency fᵣ of the LC filters 41 and 42 is set to a value lower than at least half of the frequency f_{rip_h} of the high-frequency components 32a and 32b.

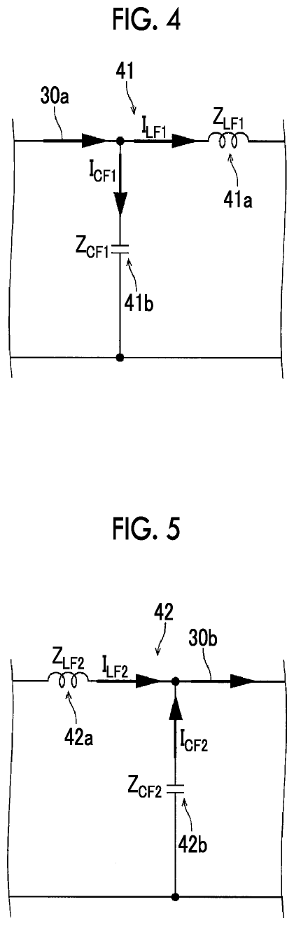

Specifically, as shown in FIG. 4, in a case where the pulsating flow 30a is split into the capacitor 41b and the reactor 41a, a ratio between a current I_{CF1} flowing through the capacitor 41b and a current I_{LF1} flowing through the reactor 41a changes according to a ratio between an impedance Z_{CF1} of the capacitor 41b and an impedance Z_{LF1} of the reactor 41a. The resonance frequency fᵣ of the capacitor 41b and the reactor 41a is represented by fᵣ=1/(2π×√(LF1×CF1)) using an inductance LF1(∝Z_{LF1}) of the reactor 41a and a capacitance CF1 (∝⁻¹ Z_{CF1}) of the capacitor 41b. Assuming that the frequency of the high-frequency component 32a of the pulsating flow 30a is f, in a case where f=fᵣ, Z_{CF1}=Z_{LF1} and I_{LF1}:I_{CF1}=1:1. Further, in a case where f=2fᵣ, Z_{LF1}:Z_{CF1}=2:0.5 and I_{LF1}:I_{CF1}=1:4. Therefore, by setting the impedance Z_{CF1} of the capacitor 41b and the impedance Z_{LF1} of the reactor 41a such that the resonance frequency fᵣ becomes fᵣ≤½×f, 80% or more of the high-frequency component 32a of the pulsating flow 30a can be split into the capacitor 41b.

In a case where the impedance Z_{CF1} of the capacitor 41b and the impedance Z_{LF1} of the reactor 41a are set such that the resonance frequency fᵣ becomes fᵣ≤½×f, the impedance Z_{LF1} with respect to the low-frequency component 31 of the pulsating flow 30a has a minute value (almost negligible value). In this case, the low-frequency component 31 is split into the capacitor 41b and the bulk capacitor 20 at a ratio between the capacity (electrostatic capacity) of the capacitor 41b and the capacity (electrostatic capacity) of the bulk capacitor 20, respectively. Therefore, most of the low-frequency component 31 (99% or more) of the pulsating flow 30a flows through the bulk capacitor 20.

As shown in FIG. 5, in a case where the pulsating flow 30b is caused to flow in from the capacitor 42b and the reactor 42a, the resonance frequency fᵣ can be set in the same manner as in a case where the pulsating flow 30a is split into the capacitor 41b and the reactor 41a. That is, the resonance frequency fᵣ of the capacitor 42b and the reactor 42a is represented by fᵣ=1/(2π×√(LF2×CF2)) using an inductance LF2 (∝⁻¹ Z_{LF2}) of the reactor 42a and a capacitance CF2 (∝⁻¹ Z_{CF2}) of the capacitor 42b. Assuming that the frequency of the high-frequency component 32b of the pulsating flow 30b is f, in a case where f=2fᵣ, Z_{LF2}:Z_{CF2}=2:0.5 and I_{LF2}:I_{CF2}=1:4. Therefore, by setting the impedance Z_{CF2} of the capacitor 42b and the impedance Z_{LF2} of the reactor 42a such that the resonance frequency fᵣ becomes fᵣ≤½×f, 80% or more of the high-frequency component 32b of the pulsating flow 30b can be caused to flow in from the capacitor 42b.

(Method of Designing Bulk Capacitor)

Next, a method of designing the bulk capacitor 20 will be described.

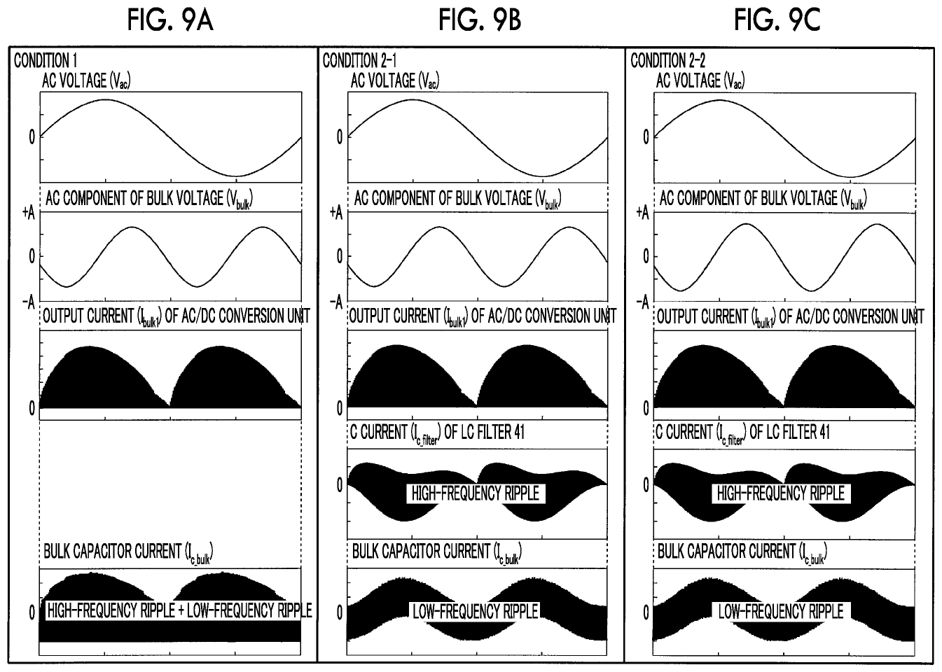

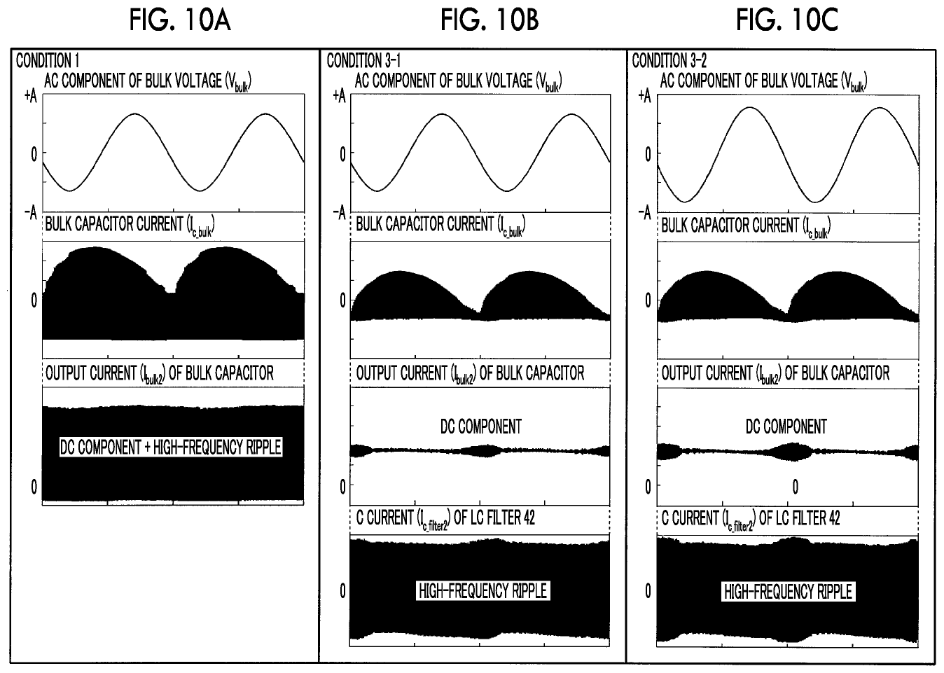

First, by simulation, a minimum value of the capacity (electrostatic capacity) of the bulk capacitor 20 is determined such that a voltage applied to the bulk capacitor 20 (hereinafter fluctuation in a bulk voltage V_{bulk} (AC component) (refer to FIGS. 9A to 10C)) is within an allowable range. In FIGS. 9A to 10C, an upper limit value and a lower limit value of the allowable range of the fluctuation in the bulk voltage V_{bulk} are respectively represented by +A and −A.

Next, an effective value of the current flowing through each of the plurality of electrolytic capacitors included in the bulk capacitor 20 is checked from the simulation.

Next, a minimum number of the electrolytic capacitors to be used (in parallel) is determined based on the effective value of the current flowing through each of the plurality of electrolytic capacitors.

Next, the effective value of the current flowing through each of the plurality of electrolytic capacitors is divided by the minimum number of the electrolytic capacitors to be used to calculate an effective value of the current flowing per electrolytic capacitor.

Next, in a case where the effective value of the current flowing per electrolytic capacitor is within a rated current value of the electrolytic capacitor, the number of the electrolytic capacitors used (the number in parallel) is determined. In a case where the effective value of the current flowing per electrolytic capacitor exceeds the rated current value of the electrolytic capacitor, the number of the electrolytic capacitors (in parallel) is increased and the effective value of the current flowing through each of the plurality of electrolytic capacitors is divided by the minimum number of the electrolytic capacitors to be used (in parallel) again to calculate the effective value of the current flowing per electrolytic capacitor.

(Effect of Reducing Capacity of Bulk Capacitor by LC Filter)

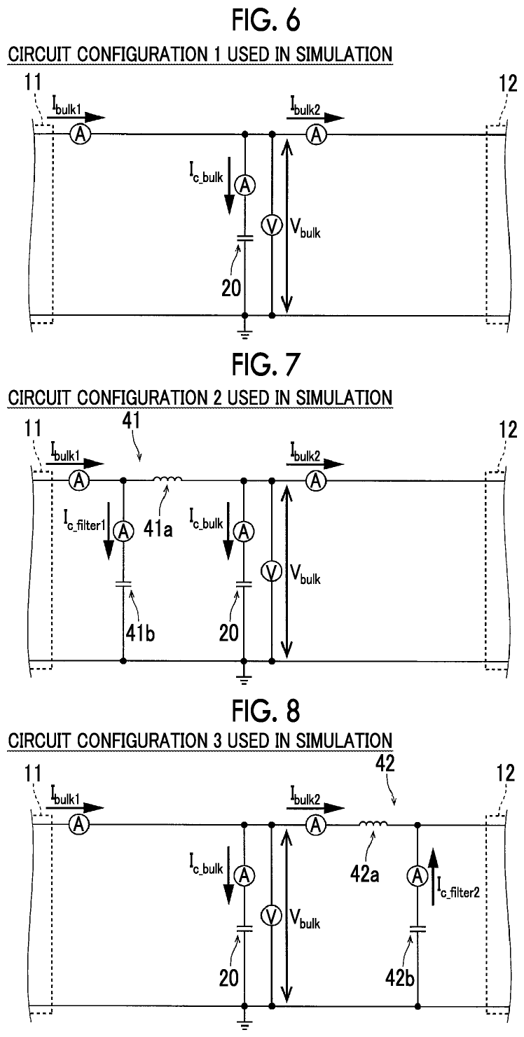

Next, with reference to FIGS. 6 to 10C, an effect of reducing the capacity of the bulk capacitor 20 by the LC filters 41 and 42 will be described using simulation results.

First, four types of circuit configurations used in the simulation will be described. As shown in FIG. 6, in a first circuit configuration (circuit configuration 1), the LC filter 41 is not provided between the AC/DC conversion unit 11 and the bulk capacitor 20, and the LC filter 42 is not provided between the DC/DC conversion unit 12 and the bulk capacitor 20. Further, as shown in FIG. 7, in a second circuit configuration (circuit configuration 2), the LC filter 41 is provided between the AC/DC conversion unit 11 and the bulk capacitor 20, and the LC filter 42 is not provided between the DC/DC conversion unit 12 and the bulk capacitor 20. Further, as shown in FIG. 8, in a third circuit configuration (circuit configuration 3), the LC filter 41 is not provided between the AC/DC conversion unit 11 and the bulk capacitor 20, and the LC filter 42 is provided between the DC/DC conversion unit 12 and the bulk capacitor 20.

Next, a simulation (hereinafter referred to as simulation 1) will be described in which the case where the LC filter 41 is not provided between the AC/DC conversion unit 11 and the bulk capacitor 20 is compared with the case where the LC filter 41 is provided therebetween, using the circuit configuration 1 of FIG. 6 and the circuit configuration 2 of FIG. 7.

In the simulation 1, first, the bulk voltage V_{bulk}, an output current output from the AC/DC conversion unit 11 (hereinafter an output current I_{bulk1} of the AC/DC conversion unit 11), and a current flowing through the bulk capacitor 20 (hereinafter a bulk capacitor current I_{c_bulk}) in a case where an AC voltage V_{ac} (refer to FIGS. 9A to 9C) is applied to the AC/DC conversion unit 11 are calculated, in the circuit configuration 1 (without LC filter 41 and without LC filter 42) as shown in FIG. 6. Then, a simulation result shown in FIG. 9A is obtained. FIG. 9A shows the simulation result, in the circuit configuration 1 (refer to FIG. 6), in a case (condition 1) where N₁ electrolytic capacitors are connected in parallel such that the effective value of the current flowing per electrolytic capacitor does not exceed a rated current value Iᵣ of the electrolytic capacitor. The effective value of the current flowing per electrolytic capacitor under the condition 1 is I₁ (<Iᵣ).

As shown in FIG. 9A, since the output current I_{bulk1} of the AC/DC conversion unit 11 flows to the bulk capacitor 20 side in the configuration without the LC filter 41, a waveform of the bulk capacitor current I_{c_bulk} (low-frequency ripple+high-frequency ripple) is greatly affected by a low-frequency ripple and high-frequency ripple of the output current I_{bulk1} of the AC/DC conversion unit 11. Further, under the condition 1, it is shown that the fluctuation in the bulk voltage V_{bulk} (AC component) is far from the upper limit value (+A) and the lower limit value (−A) of the allowable range (there is margin for the allowable range). Therefore, it can be said that the condition 1 is a state in which the current flowing into the bulk capacitor 20 (bulk capacitor current I_{c_bulk}) is too large and an extra electrolytic capacitor is attached for the allowable range of the bulk voltage V_{bulk}.

Next, the bulk voltage V_{bulk}, the output current I_{bulk1} of the AC/DC conversion unit 11, a current flowing through the capacitor 41b of the LC filter 41 (hereinafter C current I_{c_filter1} of the LC filter 41), and the bulk capacitor current I_{c_bulk}, in a case where the AC voltage V_{ac} is input to the AC/DC conversion unit 11, are calculated, in the circuit configuration 2 (with LC filter 41 and without LC filter 42) as shown in FIG. 7. Then, a simulation result shown in FIG. 9B is obtained. FIG. 9B shows the simulation result, in the circuit configuration 2, in a case (condition 2-1) where the N₁ electrolytic capacitors are connected in parallel (similar to condition 1). The effective value of the current flowing per electrolytic capacitor under the condition 2-1 is I₂ (<Iᵣ).

As shown in FIG. 9B, in the configuration provided with the LC filter 41, the output current I_{bulk1} of the AC/DC conversion unit 11 is separated into the C current I_{c_filter1} (most of high-frequency ripple (high-frequency component)) of the LC filter 41 and the bulk capacitor current I_{c_bulk} (low-frequency ripple (low-frequency component)+part of high-frequency ripple). That is, the bulk capacitor current I_{c_bulk} becomes small by providing the LC filter 41 compared with the case where the LC filter 41 is not provided (case of condition 1 shown in FIG. 9A). Accordingly, the effective value I₂ of the current flowing per electrolytic capacitor under the condition 2-1 is smaller than the effective value I₁ of the current flowing per electrolytic capacitor under the condition 1 (there is margin (small enough) for rated current value Iᵣ of electrolytic capacitor). Further, under the condition 2-1, the number of parallel electrolytic capacitors (N₁) is equal to that of the condition 1. Thus, the fluctuation in the bulk voltage V_{bulk} (AC component) is equal to that of the condition 1. That is, under the condition 2, it is shown that the fluctuation in the bulk voltage V_{bulk} (AC component) is far from the upper limit value (+A) and the lower limit value (−A) of the allowable range (there is margin for the allowable range). Therefore, it can be said that the number of parallel electrolytic capacitors can be reduced under the condition 2-1.

Next, the number of parallel electrolytic capacitors is reduced from that of the condition 2-1, and then the bulk voltage V_{bulk}, the output current I_{bulk1} of the AC/DC conversion unit 11, and the bulk capacitor current I_{c_bulk} in a case where the AC voltage V_{ac} (refer to FIGS. 9A to 9C) is applied to the AC/DC conversion unit 11 are calculated, in the circuit configuration 2 (with LC filter 41 and without LC filter 42) as shown in FIG. 7. Then, a simulation result shown in FIG. 9C is obtained. FIG. 9C shows the simulation result, in the circuit configuration 2 (refer to FIG. 7), in a case (condition 2-2) where an effective value (I₃) of the current flowing per electrolytic capacitor does not exceed the rated current value Iᵣ of the electrolytic capacitor, and N₂ (<N₁), which is less than the number of parallel electrolytic capacitors under the condition 2-1, electrolytic capacitors are connected in parallel. The effective value of the current flowing per electrolytic capacitor under the condition 2-2 is I₃ (<Iᵣ).

As shown in FIG. 9C, under the condition 2-2, peak values (maximum value and minimum value) of the fluctuation in the bulk voltage V_{bulk} (AC component) approach the upper limit value (+A) and the lower limit value (−A) of the allowable range (margin for allowable range is reduced) by the amount that the number of parallel electrolytic capacitors is smaller than that of condition 2-1. Here, it is preferable in design that the peak values (maximum value and minimum value) of the fluctuation in the bulk voltage V_{bulk} (AC component) are near the upper limit value (+A) and the lower limit value (−A) of the allowable range. That is, regarding the fluctuation in the bulk voltage V_{bulk} (AC component), it can be said that an optimum design is made under the condition 2-2. In addition, the effective value I₃ of the current flowing per electrolytic capacitor under the condition 2-2 is larger than the effective value I₂ of the current flowing per electrolytic capacitor under the condition 2-1 by the amount that the number of parallel electrolytic capacitors is smaller than that of condition 2-1. Accordingly, under the condition 2-2, the effective value of the current flowing per electrolytic capacitor is relatively close to the rated current value Iᵣ of the electrolytic capacitor, as in the condition 1. That is, regarding the effective value of the current flowing per electrolytic capacitor, it can be said that an optimum design is made under the condition 2-2.

From the comparison between the above conditions 1 and 2-2, it is shown that the number of the electrolytic capacitors used in the bulk capacitor 20 can be reduced by providing the LC filter 41 as compared with the case where the LC filter 41 is not provided.

Next, a simulation (hereinafter referred to as simulation 2) will be described in which the case where the LC filter 42 is not provided between the DC/DC conversion unit 12 and the bulk capacitor 20 is compared with the case where the LC filter 42 is provided therebetween, using the circuit configuration 1 of FIG. 6 and the circuit configuration 3 of FIG. 8.

In the simulation 2, first, the bulk voltage V_{bulk}, the bulk capacitor current I_{c_bulk}, and an output current I_{bulk2} of the bulk capacitor 20 in a case where the AC voltage V_{ac} is applied to the AC/DC conversion unit 11 are calculated, in the circuit configuration 1 (without LC filter 41 and without LC filter 42) as shown in FIG. 6. Then, a simulation result shown in FIG. 10A is obtained. FIG. 10A shows the simulation result, in the circuit configuration 1, in a case (condition 1) where the N₁ electrolytic capacitors are connected in parallel such that the effective value of the current flowing per electrolytic capacitor does not exceed the rated current value Iᵣ of the electrolytic capacitor. The effective value of the current flowing per electrolytic capacitor under the condition 1 is I₁ (<Iᵣ).

As shown in FIG. 10A, since the output current I_{bulk2} of the bulk capacitor 20 is a current flowing through the DC/DC conversion unit 12 as it is in the configuration without the LC filter 42, a waveform of the output current I_{bulk2} of the bulk capacitor 20 (DC component (direct-current component 33)+high-frequency ripple (high-frequency component)) includes the DC component and high-frequency ripple of the current flowing through the DC/DC conversion unit 12. Further, under the condition 1, the fluctuation in the bulk voltage V_{bulk} (AC component) is far from the upper limit value (+A) and the lower limit value (−A) of the allowable range (there is margin for the allowable range), as described above. Therefore, it can be said that the condition 1 is the state in which the current flowing into the bulk capacitor 20 (bulk capacitor current I_{c_bulk}) is too large and an extra electrolytic capacitor is attached for the allowable range of the bulk voltage V_{bulk}, as described above.

Next, the bulk voltage V_{bulk}, the bulk capacitor current I_{c_bulk}, the output current I_{bulk2} of the bulk capacitor 20, and a current flowing through the capacitor 42b of the LC filter 42 (hereinafter C current I_{c_filter2} of LC filter 42) in a case where the AC voltage V_{ac} is input to the AC/DC conversion unit 11 are calculated, in the circuit configuration 3 (without LC filter 41 and with LC filter 42) as shown in FIG. 8. Then, a simulation result shown in FIG. 10B is obtained. FIG. 10B shows the simulation result, in the circuit configuration 3, in a case (condition 3-1) where the N₁ electrolytic capacitors are connected in parallel (similar to condition 1). The effective value of the current flowing per electrolytic capacitor under the condition 3-1 is I₄ (<Iᵣ).

As shown in FIG. 10B, in the configuration provided with the LC filter 42, the output current I_{bulk2} of the bulk capacitor 20 and the C current I_{c_filter2} of the LC filter 42 are currents flowing through the DC/DC conversion unit 12. Thus, the currents flowing through the DC/DC conversion unit 12 are separated into the output current I_{bulk2} (DC component) of the bulk capacitor 20 and the C current I_{c_filter2} (most of high-frequency ripple (high-frequency component)) of the LC filter 42. That is, the bulk capacitor current I_{c_bulk} becomes small by providing the LC filter 42 compared with the case where the LC filter 42 is not provided (case of condition 1 shown in FIG. 10A). Accordingly, the effective value I₄ of the current flowing per electrolytic capacitor under the condition 3-1 is smaller than the effective value I₁ of the current flowing per electrolytic capacitor under the condition 1 (there is margin (small enough) for rated current value Iᵣ of electrolytic capacitor). Further, under the condition 3-1, the number of parallel electrolytic capacitors (N₁) is equal to that of the condition 1. Thus, the fluctuation in the bulk voltage V_{bulk} (AC component) is equal to that of the condition 1. That is, under the condition 3-1, it is shown that the fluctuation in the bulk voltage V_{bulk} (AC component) is far from the upper limit value (+A) and the lower limit value (−A) of the allowable range (there is margin for the allowable range). Therefore, it can be said that the number of parallel electrolytic capacitors can be reduced under the condition 3-1.

Next, the number of parallel electrolytic capacitors is reduced from that of the condition 3-1, and then the bulk voltage V_{bulk}, the bulk capacitor current I_{c_bulk}, the output current I_{bulk2} of the bulk capacitor 20, and the C current I_{c_filter2} of the LC filter 42 in a case where the AC voltage V_{ac} is input to the AC/DC conversion unit 11 are calculated, in the circuit configuration 3 (without LC filter 41 and with LC filter 42) as shown in FIG. 8. Then, a simulation result shown in FIG. 10C is obtained. FIG. 10C shows the simulation result, in the circuit configuration 3 (refer to FIG. 8), in a case (condition 3-2) where an effective value (I₅) of the current flowing per electrolytic capacitor does not exceed the rated current value Iᵣ of the electrolytic capacitor, and N₃ (<N₁), which is less than the number of parallel electrolytic capacitors under the condition 3-1, electrolytic capacitors are connected in parallel. The effective value of the current flowing per electrolytic capacitor under the condition 3-2 is I₅ (<Iᵣ).

As shown in FIG. 10C, under the condition 3-2, the fluctuation in the bulk voltage V_{bulk} (AC component) approaches the upper limit value (+A) and the lower limit value (−A) of the allowable range (margin for allowable range is reduced) by the amount that the number of parallel electrolytic capacitors is smaller than that of condition 3-1. That is, regarding the fluctuation in the bulk voltage V_{bulk} (AC component), it can be said that an optimum design is made under the condition 3-2, as in the condition 2-2 described above. In addition, the effective value I₅ of the current flowing per electrolytic capacitor under the condition 3-2 is larger than the effective value I₄ of the current flowing per electrolytic capacitor under the condition 3-1 by the amount that the number of parallel electrolytic capacitors is smaller than that of condition 3-1. Accordingly, under the condition 3-2, the effective value of the current flowing per electrolytic capacitor is relatively close to the rated current value Iᵣ of the electrolytic capacitor, as in the condition 1. That is, regarding the effective value of the current flowing per electrolytic capacitor, it can be said that an optimum design is made under the condition 3-2, as in the condition 2-2 described above.

From the comparison between the above conditions 1 and 3-2, it is shown that the number of the electrolytic capacitors used in the bulk capacitor 20 can be reduced by providing the LC filter 42 as compared with the case where the LC filter 42 is not provided.

(Effect of Embodiment)

In the present embodiment, the following effects can be obtained.

In the present embodiment, as described above, the LC filters 41 and 42 that absorb at least a part of the high-frequency components 32a and 32b of the pulsating flows 30a and 30b are provided between the AC/DC conversion unit 11, the DC/DC conversion unit 12, and the bulk capacitor 20. Accordingly, since at least a part of the high-frequency components 32a and 32b of the pulsating flows 30a and 30b is absorbed by the LC filters 41 and 42, it is possible to reduce the high-frequency components 32a and 32b included in the pulsating flows 30a and 30b (current pulsation) flowing through the bulk capacitor 20. Accordingly, since a total amount of the current flowing through the bulk capacitor 20 can be reduced, it is possible to reduce the number of the capacitors (electrolytic capacitors) used as the bulk capacitor 20 required to smooth the pulsating flows 30a and 30b in the bulk capacitor 20. In the present embodiment, as described above, the LC filters 41 and 42 include the reactors 41a and 42a and the capacitors 41b and 42b. Accordingly, with the reactors 41a and 42a that easily induce the low-frequency component 31 and the capacitors 41b and 42b that easily induce the high-frequency components 32a and 32b, it is possible to easily induce at least a part of the high-frequency components 32a and 32b of the pulsating flows 30a and 30b into the capacitors 41b and 42b. Accordingly, with the relatively simple configurations of the reactors 41a and 42a and the capacitors 41b and 42b, it is possible to absorb at least a part of the high-frequency components 32a and 32b of the pulsating flows 30a and 30b. As a result, it is possible to reduce the number of the capacitors (electrolytic capacitors) used as the bulk capacitor 20 while suppressing the circuit configuration to be complicated. Further, with the adjustment of the resonance frequency fᵣ of the LC filters 41 and 42, the low-frequency component 31 and the high-frequency components 32a and 32b can be easily induced into the reactors 41a and 42a and the capacitors 41b and 42b, respectively. Therefore, it is possible to configure the reactors 41a and 42a and the capacitors 41b and 42b used in the LC filters 41 and 42 with parts having relatively small capacity. Accordingly, since the LC filters 41 and 42 can be made smaller than the capacitor (electrolytic capacitor) used as the bulk capacitor 20, it is possible to expect miniaturization of the device.

Further, in the present embodiment, as described above, the LC filters 41 and 42 are configured to induce at least a part of the high-frequency components 32a and 32b of the pulsating flows 30a and 30b into the capacitors 41b and 42b and induce the low-frequency component 31 or the direct-current component 33 and a part of the remaining of the high-frequency components 32a and 32b of the pulsating flows 30a and 30b into the reactor 41a and 42a. Accordingly, since at least a part of the high-frequency components 32a and 32b of the pulsating flows 30a and 30b is induced into the capacitors 41b and 42b, it is possible to surely absorb at least a part of the high-frequency components 32a and 32b of the pulsating flows 30a and 30b in the LC filters 41 and 42. Further, since the low-frequency component 31 or the direct-current component 33 of the pulsating flows 30a and 30b and a part of the remaining of the high-frequency components 32a and 32b are induced into the reactors 41a and 42a, it is possible to surely smooth the low-frequency component 31 or the direct-current component 33 and a part of the remaining of the high-frequency components 32a and 32b of the pulsating flows 30a and 30b with the bulk capacitor 20 via the reactors 41a and 42a.

In the present embodiment, as described above, the resonance frequency fᵣ of the LC filters 41 and 42 is set to a value lower than at least the frequency f_{rip_h} of the high-frequency components 32a and 32b. Accordingly, since more than 50% of the high-frequency components 32a and 32b can be absorbed by the capacitors 41b and 42b in the LC filters 41 and 42, it is possible to surely reduce the high-frequency components 32a and 32b included in the pulsating flows 30a and 30b flowing through the bulk capacitor 20.

In the present embodiment, as described above, the resonance frequency fᵣ of the LC filters 41 and 42 is set to a value lower than at least half of the frequency f_{rip_h} of the high-frequency components 32a and 32b. Accordingly, since more than 80% of the high-frequency components 32a and 32b can be absorbed by the capacitors 41b and 42b in the LC filters 41 and 42, it is possible to more surely reduce the high-frequency components 32a and 32b included in the pulsating flows 30a and 30b flowing through the bulk capacitor 20.

In the present embodiment, as described above, the bulk capacitor 20 is an electrolytic capacitor. Further, the capacitors 41b and 42b are film capacitors. Accordingly, it is possible to efficiently smooth the components other than the high-frequency components 32a and 32b of the pulsating flows 30a and 30b with the electrolytic capacitor suitable for smoothing the components other than the high-frequency components 32a and 32b and efficiently absorb (smooth) the high-frequency components 32a and 32b of the pulsating flows 30a and 30b with the film capacitor suitable for smoothing the high-frequency components 32a and 32b. Accordingly, since the increase in capacity of the capacitors 41b and 42b can be suppressed, it is possible to suppress the increase in size of the LC filters 41 and 42.

In the present embodiment, as described above, the pulsating flows 30a and 30b include the low-frequency component 31 or the direct-current component 33 corresponding to the frequency of the power converted by the AC/DC conversion unit 11 and the DC/DC conversion unit 12 and the high-frequency components 32a and 32b corresponding to the operation frequencies of the AC/DC conversion unit 11 and the DC/DC conversion unit 12. Accordingly, it is possible to effectively use the LC filters 41 and 42 configured to induce at least a part of the high-frequency components 32a and 32b of the pulsating flows 30a and 30b into the capacitors 41b and 42b and the low-frequency components 31 or the direct-current component 33 and a part of the remaining of the high-frequency components 32a and 32b of the pulsating flows 30a and 30b into the reactors 41a and 42a.

In the present embodiment, as described above, the AC/DC conversion unit 11 is configured to convert the alternating-current power into the direct-current power. Further, the bulk capacitor 20 is configured to smooth the pulsating flow 30a output from the AC/DC conversion unit 11. The LC filter 41 is configured to absorb at least a part of the high-frequency component 32a from the pulsating flow 30a. Accordingly, it is possible to reduce the number of the capacitors (electrolytic capacitors) used as the bulk capacitor 20 for smoothing the pulsating flow 30a output from the AC/DC conversion unit 11.

In the present embodiment, as described above, the DC/DC conversion unit 12 is configured to convert the voltage of direct-current power. Further, the bulk capacitor 20 is configured to smooth the pulsating flow 30b input to the DC/DC conversion unit 12. The LC filter 42 is configured to absorb at least a part of the high-frequency component 32b from the pulsating flow 30b. Accordingly, it is possible to reduce the number of the capacitors (electrolytic capacitors) used as the bulk capacitor 20 for smoothing the pulsating flow 30b input to the DC/DC conversion unit 12.

### Modification Example

The embodiments disclosed this time is required to be considered as examples in all respects and not restrictive. The scope of the present invention is indicated not by the description of the above embodiment but by the scope of claims and further includes all changes (modification examples) within the meaning and scope equivalent to the scope of claims.

For example, in the above embodiment, the resonance frequency fᵣ of the LC filters 41 and 42 (filter circuit unit) is set to a value lower than at least half of the frequency f_{rip_h} of the high-frequency components 32a and 32b. However, the present invention is not limited thereto. In the present invention, the resonance frequency of the filter circuit unit may be set to a value higher than half of the frequency of the high-frequency component. It is preferable that the resonance frequency of the filter circuit unit is set to a value lower than at least the frequency of the high-frequency component.

In the above embodiment, the LC filter 41 (filter circuit unit) is provided between the AC/DC conversion unit 11 and the bulk capacitor 20 (smoothing capacitor), and the LC filter 42 (filter circuit unit) is provided between the bulk capacitor 20 (smoothing capacitor) and the DC/DC conversion unit 12. However, the present invention is not limited thereto. In the present invention, the filter circuit unit may be provided only one of between the AC/DC conversion unit and the smoothing capacitor or between the smoothing capacitor and the DC/DC conversion unit.

In the above embodiment, the power conversion device 100 is configured to include the AC/DC conversion unit 11 that converts the alternating-current power into direct-current power and the DC/DC conversion unit 12 that converts the voltage of the direct-current power. However, the present invention is not limited thereto. In the present invention, the power conversion unit may be configured to include only one of the AC/DC conversion unit or the DC/DC conversion unit.

In the above embodiment, the capacitors 41b and 42b (capacitors for filter) are film capacitors. However, the present invention is not limited thereto. In the present invention, the capacitor for filter may be a capacitor other than the film capacitor (for example, ceramic capacitor).

In the above embodiment, the power conversion device 100 is configured to convert the alternating-current power input from the single-phase alternating-current power supply 200 into the direct-current power and output the converted power to the load 300. However, the present invention is not limited thereto. In the present invention, the power conversion device may be configured to convert the alternating-current power input from a three-phase alternating-current power supply into the direct-current power and output the converted power to a load.

In the above embodiment, the AC/DC conversion unit 11 is configured to perform the full-bridge switching. However, the present invention is not limited thereto. In the present invention, the AC/DC conversion unit may be configured to perform switching of a two-stone system or a one-stone system.

In the above embodiment, the DC/DC conversion unit 12 is configured to have the full-bridge circuit configuration. However, the present invention is not limited thereto. In the present invention, the DC/DC conversion unit may be configured to have a half-bridge circuit configuration or a resonance circuit configuration.

In the above embodiment, the DC/DC conversion unit 12 is configured as the unidirectional power conversion unit. However, the present invention is not limited thereto. In the present invention, the DC/DC conversion unit may be configured as a bidirectional power conversion unit.

In the above embodiment, the “power conversion device” of the present invention is applied to the configuration in which the input alternating-current power is converted into the direct-current power and the converted power is output. However, the “power conversion device” of the present invention may be applied to a configuration in which an input direct-current power is converted into the alternating-current power and the converted power is output.

What is claimed is:

1. A power conversion device comprising:
a power conversion unit that converts input power and outputs converted power;
a smoothing capacitor that is provided on an output side or an input side of the power conversion unit and smooths a pulsating flow accompanying power conversion in the power conversion unit; and
a filter circuit unit that is provided between the power conversion unit and the smoothing capacitor, includes a reactor and a capacitor for filter, and absorbs at least a part of a high-frequency component of the pulsating flow,
wherein the filter circuit unit is configured to induce at least a part of the high-frequency component of the pulsating flow into the capacitor for filter, and induce a low-frequency component or a direct-current component and a part of remaining of the high-frequency component of the pulsating flow into the reactor.

2. The power conversion device according to claim 1,
wherein a resonance frequency of the filter circuit unit is set to a value lower than at least a frequency of the high-frequency component.

3. The power conversion device according to claim 2,
wherein the resonance frequency of the filter circuit unit is set to a value lower than at least half of the frequency of the high-frequency component.

4. The power conversion device according to claim 1,
wherein the smoothing capacitor is an electrolytic capacitor, and
the capacitor for filter is a film capacitor.

5. The power conversion device according to claim 1,
wherein the pulsating flow includes the low-frequency component or the direct-current component corresponding to a frequency of the power converted by the power conversion unit, and the high-frequency component corresponding to an operation frequency of the power conversion unit.

6. The power conversion device according to claim 1,
wherein the power conversion unit includes an AC/DC conversion unit that converts alternating-current power into direct-current power,
the smoothing capacitor is configured to smooth an output current output from the AC/DC conversion unit, and
the filter circuit unit is configured to absorb at least a part of the high-frequency component from the output current.

7. The power conversion device according to claim 1,
wherein the power conversion unit includes a DC/DC conversion unit that converts a voltage of direct-current power,
the smoothing capacitor is configured to smooth an input current input to the DC/DC conversion unit, and
the filter circuit unit is configured to absorb at least a part of the high-frequency component from the input current.
